(19) United States
(12) Patent Application Publication
(10) Pub. No.: US 2020/0030181 A1
(43) Pub. Date: Jan. 30, 2020

(54) FOAM ROLLER FOR YOGA

(71) Applicant: ASIA REGENT CORPORATION, Taichung (TW)

(72) Inventors: Yi-Hung Lin, Hillsborough, CA (US); Kuo-Feng Lin, Taichung (TW)

(21) Appl. No.: 16/283,713

(22) Filed: Feb. 22, 2019

Related U.S. Application Data
(63) Continuation of application No. 16/049,566, filed on Jul. 30, 2018.

(51) Int. Cl. A61H 15/00; A63B 22/20

(52) U.S. Cl. CPC A61H 15/0092; A63B 22/20; A61H 2201/1253; A61H 2201/169; A61H 2015/0014

(57) ABSTRACT

A foam roller includes a tube and a pad. The tube is made of an elastic material and formed with an external face and an internal face. The external face of the tube includes facets, ridges and protuberances. Each of the ridges is formed between two adjacent ones of the facets. The protuberances are formed on the facets. The pad is made of a relatively soft and elastic material and formed on the external face of the tube. The pad includes facets, ridges and protuberances corresponding to the facets, ridges and protuberances of the tube.

### CROSS-REFERENCE

The present application is a continuation-in-part application of U.S. patent application Ser. No. 16/049,566 of which the entire disclosure is incorporated therein.

### BACKGROUND OF INVENTION

### 1. Field of Invention

The present invention relates to an exercise device for yoga and, more particularly, to a foam roller for yoga.

### 2. Related Prior Art

Yoga is a popular exercise taken by many people to increase the flexibility of their bodies. In yoga, a foam roller is often used for massage of a user's lower legs, upper legs, waist, hips, neck and back.

As disclosed in Taiwanese Patent M369777, a conventional foam column includes a tunnel extending throughout an axis thereof. Tunnel increases an extent to which the foam column is deformed under compression. However, due to the material of the foam column and the tunnel made in the foam column, the deformation of the foam column could be too much to allow the user to do yoga with the foam column.

As disclosed in Taiwanese Patents M405881 and M485060, a conventional foam roller includes a tube covered by a pad. Massaging portions are provided on an external face of the pad. The massaging portions are bosses or ribs for contacting and massaging a user and, more particularly, for stimulating meridians, lymphatic glands and acupunctures.

However, each of the conventional foam column and the conventional roller provides a substantially consistent degree of hardness (or flexibility) over the entire external face thereof. Hence, none of the conventional foam column and the conventional roller provides different intensities of massage on different users or different body parts of a user.

The present invention is therefore intended to obviate or at least alleviate the problems encountered in prior art.

### SUMMARY OF INVENTION

It is an objective of the present invention to provide a foam roller with various portions to provide different degrees of hardness to provide a user with different degrees of massage.

It is another objective of the present invention to provide a foam roller that provides pauses in rolling to exert intermittent movement on a user to improve the effect of the massage.

To achieve the foregoing objectives, the foam roller includes a tube and a pad. The tube is made of an elastic material and formed with an external face and an internal face. The external face of the tube includes facets, ridges and protuberances. Each of the ridges is formed between two adjacent ones of the facets. The protuberances are formed on the facets. The pad is made of a relatively soft and elastic material and formed on the external face of the tube. The pad includes facets, ridges and protuberances corresponding to the facets, ridges and protuberances of the tube.

Other objectives, advantages and features of the present invention will be apparent from the following description referring to the attached drawings.

### BRIEF DESCRIPTION OF DRAWINGS

The present invention will be described via detailed illustration of three embodiments referring to the drawings wherein:

FIG. 1 is a perspective view of a foam roller according to the first embodiment of the present invention;

FIG. 2 is a perspective view of a tube of the foam roller of FIG. 1;

FIG. 3 is a partial and cross-sectional view of the tube shown in FIG. 1;

FIG. 4 is a cut-away view of the foam roller shown in FIG. 1;

FIG. 5 is a cross-sectional view of the foam roller shown in FIG. 1;

FIG. 6 is a side view of a user using the foam roller shown in FIG. 1;

FIG. 7 is an enlarged partial side view of the user and the foam roller shown in FIG. 6;

FIG. 8 is a perspective view of a foam roller according to the second embodiment of the present invention; and

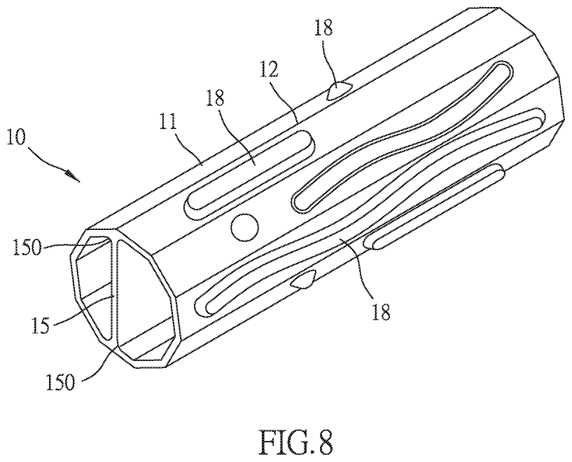

FIG. 9 is a perspective view of a foam roller according to the third embodiment of the present invention.

### DETAILED DESCRIPTION OF EMBODIMENTS

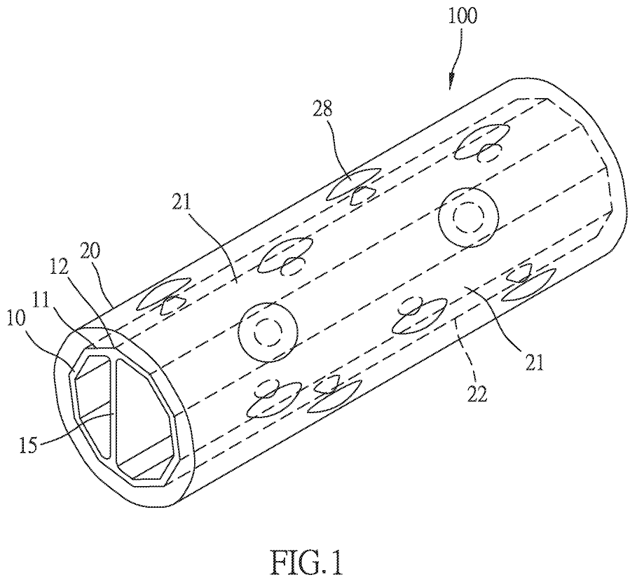

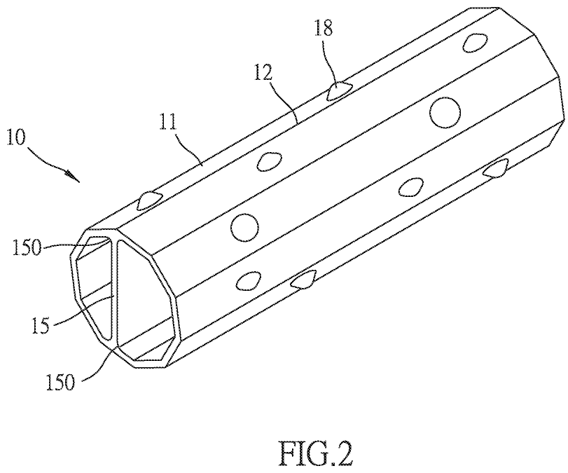

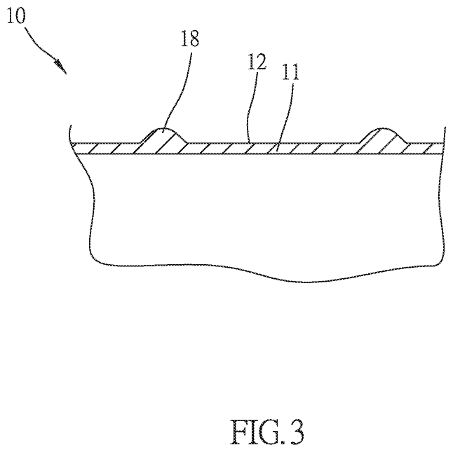

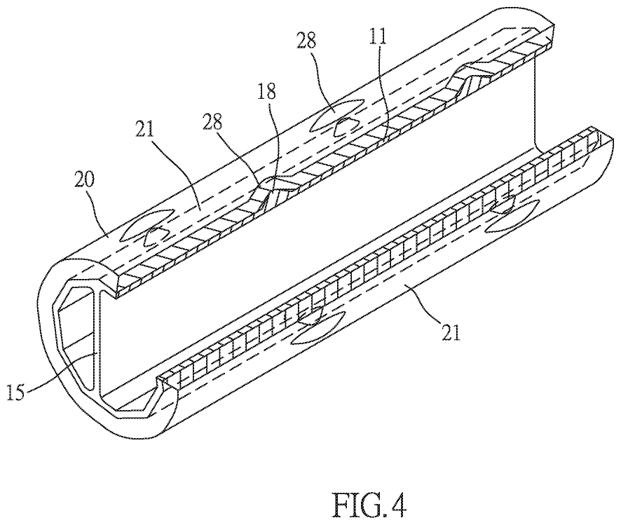

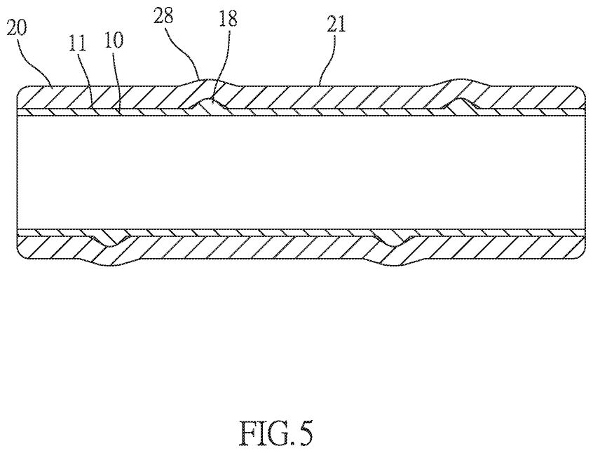

Referring to FIGS. 1 through 5, shown is a foam roller 100 for providing various intensities of massage according to a first embodiment of the present invention. The foam roller 100 includes a tube 10 wrapped by a pad 20.

The tube 10 is made of a thermoplastic material, glass fibers, carbon fibers or another proper material so that the tube is deformed when a force is exerted on it and recovers when the force is removed. The tube 10 includes an external face and an internal face. Preferably, the external face includes facets 11 and ridges 12. The number of the facets 11 can be 9, 12 or another proper number. Each of the ridges 12 is formed between two adjacent ones of the facets 11. However, the external face can be circular in another embodiment.

The tube 10 further includes protuberances 18 formed on the external face thereof. The protuberances 18 are used to exert relatively large forces on a user. The protuberances 18 are bosses in the first embodiment. Preferably, the protuberances 18 are formed on the facets 11. However, the protuberances 18 can be formed at the edges 12 in another embodiment.

The tube 10 further includes a reinforcement element 15 that is preferably a plate on the internal face of the tube 10. The reinforcement element 15 is connected to the internal face of the tube 10 at two connective portions 150. The connective portions 150 are larger than the remaining portion of the reinforcement element 15 to reinforce the connection of the reinforcement element 15 to the internal face of the tube 10. The reinforcement element 15 is biased from an axis of the internal face of the tube 10.

The pad 20 is made of soft, elastic and anti-skid thermoplastic elastomer such as ethylene vinyl acetate (“EVA”). The pad 20 is formed on and around the external face of the tube 10 by a proper process such as hot melting, hot pressing, injection molding and foaming Thus, the pad 20 includes an external face corresponding to the external face of the tube 10. Preferably, the external face of the pad 20 includes facets 21 corresponding to the facets 11. There is an edge 22 between every two adjacent facets 21. The facets 21 are formed with protuberances 28 corresponding to the protuberances 18.

The foam roller 100 can be used in various modes. The user lays his or her neck, legs, back or waist on the foam roller 100 and uses his or her neck, legs, back or waist to roll the foam roller 100. Thus, the user massages his or her neck, legs, back or waist on the foam roller 100.

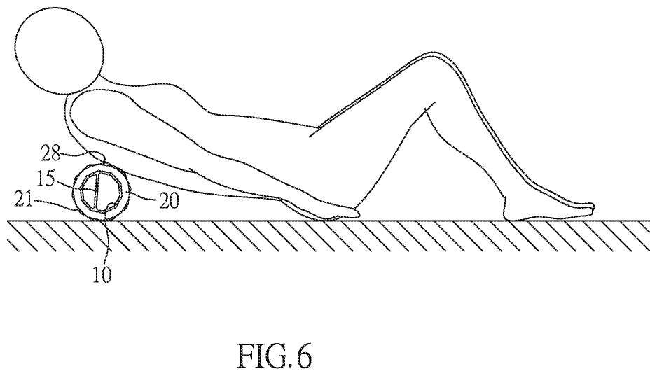

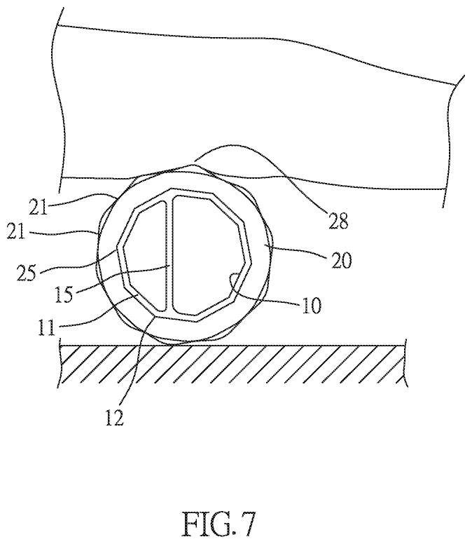

Referring to FIG. 6, the user uses the foam roller 100 to message his or her back for example. Referring to FIG. 7, the user uses the foam roller 100 to message his or her legs for example.

The facets 21, the ridges 22 and the protuberances 28 press the user's neck, legs, back or waist to different extents. The facets 21, the ridges 22 and the protuberances 28 ensure the rolling of the foam roller 100 on a floor by avoid skid of the foam roller 100 on the floor. Moreover, the facets 21, the ridges 22 and the protuberances 28 cause the foam roller 100 to rattle while rolling. The facets 21 press the user's neck, legs, back or waist mildly. The ridges 22 and the protuberances 28 press the user's neck, legs, back or waist intensively. Thus, this alternate arrangement of mild pressing and intensive pressing provides deep massage to the muscles and nerve in the user's neck, legs, back or waist. Moreover, the facets 21, the ridges 22 and the protuberances 28 retain the foam roller 100 in position when the foam roller 100 is not used.

Referring to 8, shown is a foam roller 100 according to a second embodiment of the present invention. The second embodiment is identical to the first embodiment except for that the protuberances 18 include bosses and ribs. Accordingly, the protuberances 28 include bosses and ribs. The protuberances 28 are formed with various length, width and height and in various shapes and locations.

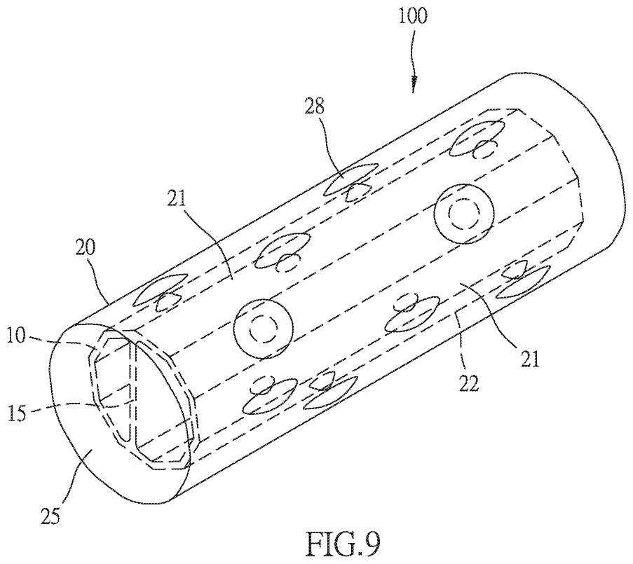

Referring to FIG. 9, shown is a foam roller 100 according to a third embodiment of the present invention. The third embodiment is identical to the first embodiment except for including two lateral covering portions 25 for covering two open ends of the tube 10. Thus, the pad 20 wraps and conceals the entire tube 10.

The foam roller 100 can include two plugs fitted in the open ends of the tube 10 in another embodiment. The foam roller 100 can include two covers located on the open ends of the tube 10 in another embodiment.

The present invention has been described via the illustration of the embodiments. Those skilled in the art can derive variations from the embodiments without departing from the scope of the present invention. Therefore, the embodiments shall not limit the scope of the present invention defined in the claims.

1. A foam roller comprising:
a tube (10) made of an elastic material and formed with an external face and an internal face, wherein the external face of the tube (10) comprises facets (11), ridges (22), each of which is formed between two adjacent ones of the facets (11), and protuberances (18) formed on the facets (11), wherein the internal face of the tube (10) extends around and along an axis;
a reinforcement element (15) in the form of a plate being biased from the axis and comprising two connective portions (150) connected to the internal face of the tube (10); and
a pad (20) made of a soft and elastic material and formed on the external face of the tube (10), wherein the pad (20) comprises facets (21), ridges (22) and protuberances (28) corresponding to the facets (11), ridges (12) and protuberances (18) of the tube (10).

2. The foam roller according to claim 1, wherein the protuberances (18, 28) are formed with various length, width and height and in various shapes and locations.

3. (canceled)

4. The foam roller according to claim 1, wherein the pad (20) is made of thermoplastic elastomer.

5. The foam roller according to claim 4, wherein the thermoplastic elastomer comprises ethylene vinyl acetate (“EVA”).

6. (canceled)
